(19) United States
(12) Patent Application Publication
(10) Pub. No.: US 2017/0067002 A1
(43) Pub. Date: Mar. 9, 2017

(54) FILMS, COMPOSITIONS, AND ARTICLES HAVING AT LEAST TWO DIFFERENT AVERSIVE AGENTS AND METHODS RELATED THERETO

(71) Applicant: The Procter & Gamble Company, Cincinnati, OH (US)

(72) Inventor: David Xavante CUMMING, Brussels (BE)

(21) Appl. No.: 15/252,281

(22) Filed: Aug. 31, 2016

(30) Foreign Application Priority Data
Sep. 4, 2015 (EP) 15183851.3

(51) Int. Cl. C11D 17/04; C11D 11/00; C11D 3/32; C11D 3/37

(52) U.S. Cl. CPC C11D 17/042; C11D 3/3753; C11D 11/0017; C11D 11/0023; C11D 3/32

(57) ABSTRACT

Films, compositions, and articles, for example unit dose articles, having at least two different aversive agents. Methods related thereto.

### FIELD OF THE INVENTION

The present disclosure relates to films, compositions, and articles, for example unit dose articles, having at least two different aversive agents and methods related thereto.

### BACKGROUND OF THE INVENTION

Aversive agents, such as bittering agents like BITREX™ (denatonium benzoate), are commonly added to certain compositions, such as pesticides, cleaning compositions, or automotive compositions, in order to deter accidental ingestion. Typically, aversive agents act on the sense of taste and are found to be quite unpleasant, resulting in a repulsive reaction when they are tasted or consumed.

It is believed that this repulsive reaction finds its basis in our evolutionary history. For example, our genetic code (e.g., twenty-five identified TAS2R genes) in part controls the receptors on our tongues that are able to perceive bitter tastes. Many toxins have a bitter taste, and those of our ancestors who both perceived the bitter taste of such toxins and were repulsed by it were therefore less likely to consume to toxin, and more likely to survive, reproduce, and pass on the gene(s) that controlled such perception and repulsive reaction.

However, it is believed that over the course of human evolution, the selective pressures on such genes might have been relaxed due to change in diet, use of fire, and reliance on other means of toxin avoidance, resulting in reduced sensory capabilities of humans compared to other mammals. Thus, it is believed that the prevalence of such genes controlling humans' abilities to perceive such bitter tastes have been reduced in frequency.

Additionally, it is known that sensitivity to certain tastes, such as bitterness, can vary with other non-genetic factors. Relevant factors may include age, sex, and personal habits, such as smoking and coffee drinking.

These differences in taste perceptions and sensitivities mean that the ability to taste certain aversive agents can vary widely within and across populations. For example, phenylthiocarbamide (PTC) is a bitter-tasting substance to many people. However, studies have shown that approximately half (50%) of Australian Aborigines cannot taste PTC, while approximately only 27-28% of people of European origin (including North American, non-Hispanic whites) are non-tasters.

Given the differences in taste perception across individuals and populations, there is a need for improved compositions (such as household care compositions), articles, and processes including aversive agents that will produce the desired aversive responses in a broad portion of a population when accidentally consumed.

### SUMMARY OF THE INVENTION

The present disclosure relates to films, compositions, and articles that include at least a first aversive agent and second aversive agent, where the first and second aversive agent are different. The first and/or second aversive agents may be present in an effective amount. The first and second aversive agent may be selected so that at least a first portion of a human population can taste the first aversive agent but not the second aversive agent, and so that at least a second portion of the human population can taste the second aversive agent but not the first aversive agent. The present disclosure further relates to methods of making such films, compositions, and articles.

More specifically, the present disclosure relates to a water-soluble film that includes a first aversive agent present in an effective amount, and a second aversive agent present in an effective amount, where the first and second aversive agents are different.

The present disclosure further relates to a cleaning or detergent composition that includes a first aversive agent present in an effective amount, and a second aversive agent present in an effective amount, where the first and second aversive agents are different.

The present disclosure further relates to a water-soluble unit dose article that includes a first aversive agent present in an effective amount, and a second aversive agent present in an effective amount, where the first and second aversive agents are different.

The present disclosure further relates to a process for making the films, compositions, and unit dose articles described herein, the process including the step of providing a first aversive agent and a second aversive agent to a film, composition, or unit dose article or component thereof, for example where the first and second aversive agents are selected so that at least a first portion of a human population can taste the first aversive agent but not the second aversive agent, and so that at least a second portion of the human population can taste the second aversive agent but not the first aversive agent.

### BRIEF DESCRIPTION OF THE DRAWINGS

FIG. 1 shows an exemplary unit dose article.

### DETAILED DESCRIPTION OF THE INVENTION

The present disclosure relates to films, compositions, and articles, for example unit dose articles, that comprise at least two different aversive agents, each present at an effective amount, as well as processes related thereto, each of which is described in more detail below. Without wishing to be bound by theory, it is believed that by including at least two different aversive agents, a broader group of consumers is likely to experience a repulsive or aversive reaction compared to if either of the aversive agents were used individually. In effect, if an individual is unable to perceive the first aversive agent, it's possible and/or likely that they'll be able to perceive the second aversive agent, so long as each is present in an effective amount.

By “effective amount,” it is meant any amount sufficient to evoke an aversive reaction in a majority of the portion of a population that is able to taste the given aversive agent. The effective amount may vary with the aversive agent, as some are more potent than others. In practical terms, an effective amount may be from about 0.0000001%, or from about 0.000001%, or from about 0.00001%, to about 5%, or to about 1%, or about 0.1%, by weight of the film, composition, or article, for example.

As used herein, the terms “include,” “includes” and “including” are meant to be non-limiting. The phases “comprising” or “comprises” are intended to include the more limiting phrases “consisting essentially of” and “consisting of.” Therefore, a composition that comprises a component may consist essentially of that component, or consist of that component.

As used herein, the terms “substantially free of” or “substantially free from” may mean that the indicated material is at the very minimum not deliberately added to the composition to form part of it, or, preferably, is not present at analytically detectable levels. It is meant to include compositions whereby the indicated material is present only as an impurity in one of the other materials deliberately included. “Substantially free” may mean that the indicated material is present at less than about 5%, or less than about 1%, or less than about 0.1%, or less than about 0.01%, or about 0%, by weight of the composition.

In this description, all concentrations and ratios are on a weight basis of the composition unless otherwise specified.

### Aversive Agent

The present compositions and/or methods include at least two different aversive agents. As used herein, an aversive agent is an agent that is intended to discourage ingestion and/or consumption of the unit dose articles described herein or components thereof, such as water-soluble films. An aversive agent may act by providing an unpleasant sensation, such as an unpleasant taste, when placed in the mouth or ingested. Such unpleasant sensations may include bitterness, pungency (or heat/spiciness), an unpleasant odor, sourness, coldness, and combinations thereof. An aversive agent may also act by causing humans and/or animals to vomit, for example via emetic agents. Suitable aversive agents include bittering agents, pungent agents, emetic agents, and mixtures thereof.

The films, compositions, unit dose articles, and processes described herein may comprise a first aversive agent and a second aversive agent. The first and second aversive agents may be present in an effective amount. The descriptions below of “aversive agents” apply equally to the first aversive agent and to the second aversive agent, as well as any other aversive agents (e.g., third aversive agents, fourth aversive agents, or more) that may be present.

The first and second aversive agents may be selected such that at least a first portion of a human population can taste the first aversive agent but not the second aversive agent. The first and second aversive agents may be selected such that at least a second portion of the human population can taste the second aversive agent but not the first aversive agent. The first and second aversive agents may be selected such that the proportion of a population that can taste at least one of the aversive agents is greater than each of the proportion that can taste the first aversive agent and the proportion that can taste the second aversive agent. The first and second aversive agents may be selected such that the portion of a human population that can taste the first aversive agent is different than, and at least does not completely overlap with, or does not overlap at all with, the portion of the human population that can taste the second aversive agent. It is contemplated that a third aversive agent and/or a fourth aversive agent and/or more aversive agents may be used in similar manners so as to cover an even greater proportion of a population.

The first aversive agent may be a first bittering agent, described in more detail below. The first bittering agent may comprise a denatonium salt or a derivative thereof. The first bittering agent comprises denatonium benzoate. The second aversive agent may be a bittering agent. The second aversive may be a pungent agent, described in more detail below.

The level of aversive agent used within or on the unit dose articles or components thereof may be at least at an effective level, which causes the desired aversive effect, and may depend on the characteristics of the specific aversive agents, for example bitter value. The level used may also be at or below such a level that does not cause undesired transfer of the aversive agents to a human and/or animal, such as transfer to hands, eyes, skin, or other body parts. The amount present may be based on the particular aversive agent's potency such that greater than 50% of humans experience an aversive effect when exposed to the given amount of the aversive agent. The aversive agent may be present at a concentration which elicits repulsive behavior within a maximum time of six seconds in cases of oral exposure.

The first and second aversive agents may be present in a weight ratio. The weight ratio of first aversive agent to second aversive agent may be from about 0.01:99.99 to about 99.99:0.01, or from about 0.1:99.1 to 99.9:0.1, or from about 1:99 to about 99:1.

The aversive agent may be provided to the unit dose article or component thereof in any suitable manner. The aversive agent may be formulated into a film-forming material during manufacture of the film, or it may be provided after the film is manufactured, or even during or after the manufacture of the unit dose article. If the aversive agent is formulated into the water-soluble film as the film is being manufactured, the water-soluble film may comprise a substrate element and an aversive agent chemically coupled to the substrate element, for example as described in US2014/0371411A1. The aversive agent may be applied to a surface of the unit dose article or component thereof, for example by spraying, printing, atomizing, dusting, powdering, coating, painting, or otherwise depositing the aversive agent directly onto the water-soluble film and/or the finished unit dose article. The aversive agent may be provided in compositions encapsulated by water-soluble film, and may migrate to the film and/or to the surface of the film, which may be facilitated by the selection of certain solvents and/or plasticizers.

When a composition comprising the aversive agent is applied to the film and/or unit dose article, the composition may be non-aqueous so as to minimize dissolution of the film and/or article. Here, by non-aqueous it is meant that the composition may comprise less than about 20%, or less than about 15%, or less than about 10%, or less than about 5%, or less than about 1%, or about 0%, or 0%, by weight of the composition, of water. The composition may comprise up to about 100%, or 80%, or 60%, or 40%, or 35%, or 30% of the aversive agent. The composition may comprise from greater than 0% to about 100%, or from about 0.001% to about 80%, or from about 0.001% to about 60%, or from about 0.001% to about 40%, or from about 0.1% to about 35%, or from about 1% to about 30% by weight of the aversive agent.

The aversive agent may be provided in any suitable form. The aversive agent may be in the form of particles comprising the aversive agent, encapsulates comprising the aversive agent, a gel matrix comprising the aversive agent, or a combination thereof. In such forms, the aversive agent may be held within or on the carrier, within the encapsulate, and/or within the gel matrix until it is contacted with a relevant substrate, such as saliva, after which the aversive agent is released.

The aversive agent may be in the form of particles comprising a carrier and the aversive agent. The carrier may be selected from the group comprising carbonate, sulphate, zeolite, talc, clay, saccharides, polysaccharides, or mixtures thereof. The carrier may comprise a polysaccharide, which may be selected from maltodextrin, cellulose or a mixture thereof.

The carrier may form a matrix into which the aversive agent is absorbed. The aversive agent may be coated onto the carrier. The carrier may form a matrix into which the aversive agent is absorbed and the aversive agent is coated onto the carrier. For example, the aversive agent may be coated onto the carrier and then at least part of the aversive agent is absorbed into the carrier.

Wherein the aversive agent is in the form of a particle, the particle may be a spray-dry particle, an agglomerate, an extrudate, or a mixture thereof.

The aversive agent maybe in the form of a gel matrix comprising the aversive agent. A gel in this case means a composition of sufficiently high viscosity such that it substantially remains adhered to the water-soluble unit dose article until intended use. The gel matrix may comprise a wax, a saccharide, or a mixture thereof.

When the aversive agent is in the form of an encapsulate, the encapsulate may be a core and shell encapsulate, where the core comprises the aversive agent. The shell may comprise polyvinyl alcohol, melamine formaldehyde, polylactide, polyglycolide, gelatin, polyacrylate, shellac, zein, chitosan, wax, hydrogenated vegetable oil, polysaccharides paraffin and mixtures thereof. The shell may comprise a polylactide-polyglycolide copolymer. The shell may comprise a hydrogenated castor oil.

The aversive agent may be selected from the group comprising naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-methoxy-4′-hydroxy-phenyl)-1, 3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof. Other suitable aversive agents are described in more detail below.

a. Bittering Agents

The aversive agent may comprise a bittering agent. The bittering agent may be present in and/or on the unit dose articles described herein and/or components thereof.

Non-limiting examples of suitable bittering agents include denatonium salts and derivatives thereof. The bittering agent may be a denatonium salt selected from the group consisting of denatonium chloride, denatonium citrate, denatonium saccharide, denatonium carbonate, denatonium acetate, denatonium benzoate, and mixtures thereof. The bittering agent may be denatonium benzoate, also known as phenylmethyl-[2-[(2,6-dimethylphenyl)amino]-2-oxoethyl]-diethylammonium benzoate, CAS no. 3732-33-6. Denatonium benzoate is commercially sold as BITREX®, available from Macfarlan Smith, Edinburgh, Scotland, UK.

The bittering agent may be a natural bitter substance. The natural bitter substance may be selected from the group consisting of glycosides, isoprenoids, alkaloids, amino acids, and mixtures thereof. For example, suitable bittering agents also include Quercetin (3,3′,4′,5,7-pentahydroxyflavone); Naringin (4′,5,7-Trihydroxyflavanone-7-rhamnoglucoside); Aucubin; Amarogentin; Dihydrofoliamentin; Gentiopicroside; Gentiopicrin; Swertiamarin; Swerosid; Gentioflavosid; Centaurosid; Methiafolin; Harpagoside; Centapikrin; Sailicin; Kondurangin; Absinthin; Artabsin; Cnicin; Lactucin; Lactucopicrin; Salonitenolid; α-thujone; β-thujone; Desoxy Limonene; Limonin; Ichangin; iso-Obacunoic Acid; Obacunone; Obacunoic Acid; Nomilin; Ichangin; Nomilinoic acid; Marrubin; Pramarrubin; Carnosol; Carnosic acid; Quassin; Brucine; Quinine hydrochloride; Quinine sulfate; Quinine dihydrochloride; Columbine; Caffeine; Threonine; Methionine; Phenylalanine; Tryptophan; Arginine; Histidine; Valine; Aspartic acid; Sucrose octaacetate; and mixtures thereof. Other suitable bittering agents include quinine bisulfate and hop extract (e.g., humulone).

Other non-limiting examples of suitable bittering agents for use as described herein are described at BitterDB (http://bitterdb.agri.huji.ac.il/dbbitter.php), which is a free searchable database of bittering agents that holds over 680 bittering agents obtained from literature and the Merck Index and their associated 25 human bitter taste receptors (hT2Rs), and in the corresponding paper Ayana Wiener; Marina Shudler; Anat Levit; Masha Y. Niv. BitterDB: a database of bitter compounds. Nucleic Acids Res 2012, 40(Database issue):D413-419.

The bittering agent may exhibit a bitter value of greater than 1,000, or greater than 5,000, or greater than 10,000, or greater than 20,000, and/or less than 10,000,000, or less than 5,000,000, or less than 1,000,000, or less than 500,000, or less than 200,000, or less than 150,000, or less than 100,000. The bittering agent may exhibit a bitter value of from about 1,000 to about 10,000,000, or from about 5,000 to about 1,000,000, or from about 10,000 to about 200,000. The bitter value is measured using the standardized process set forth in the European Pharmacopoeia (5th Edition, Stuttgart 2005, Volume 1, General Monograph Groups, 2.8.15 Bitterness Value, p. 278).

The unit dose article or component thereof may comprise a sufficient amount of the bittering agent to provide a bitter taste, for example from about 0.00001% to about 1%, or from about 0.0001% to about 0.5%, or from about 0.001% to about 0.25%, or from about 0.01% to about 0.1% by weight of the unit dose article or component thereof.

The bittering agent may be present at a level of at least 10 ppb, or at least 50 ppb. The bittering agent may be present at a level of from about 10 ppb to about 10,000 ppm, or from about 50 ppb to about 5,000 ppm, or from about 50 ppb to about 1,000 ppm, or from about 100 ppb to about 500 ppm, or from about 10 ppm to about 250 ppm as determined after storage of the article and/or film for one month 25° C. and 60% relative humidity.

b. Pungent Agents

The aversive agent may comprise a pungent agent. Pungent agents provide pungency, which is the characteristic commonly referred to as spiciness, hotness, or “heat,” often found in foods such as chili peppers.

Non-limiting examples of suitable pungent agents may include: capsicinoids (including capsaicin); vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-methoxy-4′-hydroxy-phenyl)-1, 3-dioxolane; pepper oil; pepper oleoresin; ginger oleoresin; nonylic acid vanillylamide; jamboo oleoresin; Zanthoxylum piperitum peel extract; sanshool; sanshoamide; black pepper extract; chavicine; piperine; spilanthol; and mixtures thereof. Other suitable pungent agents include polygodial, Tasmannia lanceolata extract, Capsicum extracts, or mixtures thereof. The pungent agent may comprise a capsaicinoid, for example capsaicin, dihydrocapsaicin, nordihydrocapsaicin, homodihydrocapsaicin, homocapsaicin, and/or nonivamide. The pungent agent may comprise capsaicin.

Commercially available suitable pungent agents include OPTAHEAT (Symise Flavors), HOTACT (Lipo Chemicals), and HEATENOL (Sensient Flavors).

The unit dose article and/or component thereof (e.g., water-soluble film) may comprise a sufficient amount of the pungent agent to deliver a pungent taste and/or pungent smell, for example a controlled level of pungency to a user (enough to deter ingestion but not so much as to make a human and/or animal physically ill or to accidentally transfer significant amounts to a user's hands). The article or component thereof may comprise greater than 0.0001%, or greater than 0.001%, or greater than 0.01%, or greater than 0.1%, and/or less than 20%, or less than 15%, or less than 10%, or less than 5%, or less than by 2%, or less than 1%, or less than 0.5%, by weight of the article or component, of the pungent agent. The article or component thereof may comprise from about 0.0001% to about 10%, or from about 0.001% to about 2%, or from about 0.01% to about 1%, or from about 0.1% to about 0.5%, by weight of the article or component, of the pungent agent. The pungent agent may be present at a level of at least 10 ppb, or at least 50 ppb. The pungent agent may be present at a level of from about 10 ppb to about 10,000 ppm, or from about 50 ppb to about 5,000 ppm, or from about 50 ppb to about 1,000 ppm, or from about 100 ppb to about 500 ppm, or from about 10 ppm to about 250 ppm as determined after storage of the article and/or film for one month 25° C. and 60% relative humidity.

The pungency of a pungent agent may be determined according to the well-known Scoville Scale and may be reported in Scoville heat units (SHU). The pungent agent may be selected from pungent agents having a pungency level of at least about 1,000,000 SHU, or at least about 5,000,000 SHU, or at least about 10,000,000 SHU, or at least about 15,000,000 SHU. For comparison, the pungency level of capsaicin is about 16,000,000 SHU. Pungency may also be measured by high performance liquid chromatography and determined in American Spice Trade Association (ASTA) pungency units. A measurement of one part capsaicin per million corresponds to about 15 Scoville units, and ASTA pungency units can be multiplied by 15 and reported as Scoville units.

Because it is desirable that the pungent agent be detectable in order to be an effective aversive agent, it is generally desirable that the pungency not be masked by other agents, such as cooling agents like menthol and the like. Therefore, the unit dose articles and/or components thereof may be free, for example comprising less than 5%, or less than 3%, or less than 1%, or less than 0.1%, or less than 0.01%, or less than 0.001%, or about 0%, or 0%, by weight of the article or component, of cooling agents, for example menthol and/or eucalyptus.

c. Emetic Agents

The aversive agent may comprise an emetic agent. There are two main types of emetic agents: 1) those that work directly on the gastrointestinal tract of humans and animals, and 2) those that work indirectly by stimulating the areas of the brain that control vomiting.

Non-limiting examples of suitable emetic agents that work directly on the gastrointestinal tracts are selected from the group consisting of: ipecac (ipecac syrup and/or ipecac powder) obtained from Cephaelis ipecacuanha, lobelia obtained from Lobelia inflata, mustard seed obtained from Brassica juncea, vomitoxin obtained from Fusarium graminearum, copper sulfate, and mixtures thereof. The aversive agent may comprise ipecac.

An example of an emetic agent that works indirectly by stimulating the areas of the brain that control vomiting is apomorphine (apomorphine hydrochloride).

Water-Soluble Unit Dose Article

The present disclosure relates to a water-soluble unit dose article. The article comprises a water-soluble or water-dispersible film, described in more detail below. The film may at least partially encapsulate a composition, for example a liquid composition, described in more detail below. The composition may be a detergent or cleaning composition.

More specifically, the water-soluble unit dose article may comprise at least one water-soluble film shaped such that the unit-dose article comprises at least one internal compartment surrounded by the water-soluble film. The at least one compartment comprises the detergent or cleaning composition. The water-soluble film is sealed such that the detergent or cleaning composition does not leak out of the compartment during storage. However, upon addition of the water-soluble unit dose article to water, the water-soluble film dissolves and releases the contents of the internal compartment into the wash liquor. When the article, such as a pouch, is placed in water at 20° C., a liquid composition encapsulated therein may be retained within the pouch for at least 30 seconds.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the composition according to the present invention may be comprised in at least one of the compartments. It may for example be comprised in just one compartment, or may be comprised in two compartments, or even in three compartments.

Each compartment may comprise the same or different compositions. The different compositions could all be in the same form, for example they may all be liquid, or they may be in different forms, for example one or more may be liquid and one or more may be solid. A first compartment may contain a liquid composition, and a second compartment may contain a solid composition, for example a granular or powdered composition. The detergent or cleaning composition may be present in one compartment or may be present in more than one compartment.

The water-soluble unit dose article may comprise an air bubble. The water-soluble unit dose article may be transparent, translucent, opaque, or combinations thereof.

The first and/or second aversive agent may be in or on a water-soluble or water-dispersible substrate of the unit dose article, such as a film. The first aversive agent may be present at a first location of the unit dose article, and the second aversive agent may be present at a second location of the unit dose article. The first and second locations are different. The first location may be in or on a first water-soluble or water-dispersible substrate. The second location may be in or on a second water-soluble or water-dispersible film. The first and/or second location may be in the composition. The first location may be in a water-soluble or water-dispersible film, and the second location may be on the water-soluble or water-dispersible film.

### Water-Soluble or Water-Dispersible Substrates

The unit dose articles described herein may comprise a water-soluble or water-dispersible substrate. The substrates may be any water-soluble or water-dispersible substrate that is suitable for forming a unit dose article, such as a pouch. The substrate may be in the form of a film, a fibrous web (woven or non-woven), or combinations thereof. The substrate may be a water-soluble or water-dispersible film, such as a thermoformable film.

The water-soluble or water-dispersible substrate may comprise the first and/or the second aversive agent. For example, a water-soluble film may comprise a first aversive agent present in an effective amount, and a second aversive agent present in an effective amount, where the first and second aversive agents are different. The first and second aversive agents may be selected so that at least a first portion of a human population can taste the first aversive agent but not the second aversive agent, and so that at least a second portion of the human population can taste the second aversive agent but not the first aversive agent.

The film may at least partially encapsulate a composition, such as a cleaning or detergent composition, to form a unit dose article. The film may encapsulate a liquid composition, a solid or granular composition, or mixtures thereof.

The water-soluble film preferably has a thickness of from about 20 to about 200 microns, preferably about 35 to about 150 microns, even more preferably about 50 to about 125 microns, most preferably from about 75 to about 100 microns, or about 76 microns, or about 85 microns. Different film material and/or films of different thickness may be employed in making the compartments of the present invention. A benefit in selecting different films is that the resulting compartments may exhibit different solubility or release characteristics.

The film of the present invention is soluble or dispersible in water. Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured, by the method set out here after using a glass-filter with a maximum pore size of 20 microns, described below. Water-solubility may be determined at 24° C., or preferably at 10° C.
Dissolution Method: 50 grams±0.1 gram of film material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion, or blown extrusion of the polymeric material, as known in the art. Preferably the film is obtained by an extrusion process or by a casting process.

Preferred polymers (including copolymers, terpolymers, or derivatives thereof) suitable for use as film material are selected from polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the polymers of the film material are free of carboxylate groups.

Preferably, the level of polymer in the film material, for example a PVA polymer, is at least 60%. The polymer can have any weight average molecular weight, preferably from about 1000 to 1,000,000, more preferably from about 10,000 to 300,000, yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, preferably about 20,000, and of PVA or copolymer thereof, with a weight average molecular weight of about 100,000 to about 300,000, preferably about 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers, preferably polyvinyl alcohol, which are from about 60% to about 99% hydrolysed, preferably from about 80% to about 99% hydrolysed, even more preferably from about 80% to about 90% hydrolysed, to improve the dissolution characteristics of the material. Preferred films are those supplied by Monosol (Merrillville, Ind., USA) under the trade references M8630, M8900, M8779, M8310, M9467, and PVA films of corresponding solubility and deformability characteristics. Other suitable films may include called Solublon® PT, Solublon® GA, Solublon® KC or Solublon® KL from the Aicello Chemical Europe GmbH, the films VF-HP by Kuraray, or the films by Nippon Gohsei, such as Hi Selon. Suitable films include those supplied by Monosol for use in the following Procter and Gamble products: TIDE PODS, CASCADE ACTION PACS, CASCADE PLATINUM, CASCADE COMPLETE, ARIEL 3 IN 1 PODS, TIDE BOOST ORIGINAL DUO PACs, TIDE BOOST FEBREZE SPORT DUO PACS, TIDE BOOST VIVID WHITE BRIGHT PACS, DASH, FAIRY PLATINUM. It may be preferable to use a film that exhibits better dissolution than M8630 film, supplied by Monosol, at temperatures 24° C., even more preferably at 10° C.

Preferred water soluble films are those derived from a resin that comprises a blend of polymers, preferably wherein at least one polymer in the blend is polyvinyl alcohol. Preferably, the water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons. Of the total PVA resin content in the film described herein, the PVA resin can comprise about 30 to about 85 wt % of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

The films may be water soluble copolymer films comprising a least one negatively modified monomer with the following formula:

[Y]-[G]ₙ

wherein Y represents a vinyl alcohol monomer and G represents a monomer comprising an anionic group and the index n is an integer of from 1 to 3. G can be any suitable comonomer capable of carrying of carrying the anionic group, for example G is a carboxylic acid. G may be selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid, and mixtures thereof. Suitable films may include blends of such copolymers.

The anionic group of G may be preferably selected from the group consisting of OSO₃M, SO₃M, CO₂M, OCO₂M, OPO₃M₂, OPO₃HM and OPO₂M. More preferably, the anionic group of G is selected from the group consisting of OSO₃M, SO₃M, CO₂M, and OCO₂M. Most preferably the anionic group of G is selected from the group consisting of SO₃M and CO₂M. As used herein, M is a suitable counterion known to one of ordinary skill, such as hydrogen (H+), an alkali metal (e.g., Na⁺, K⁺), an alkali earth metal (½ Ca²⁺), or ammonium (NH₄⁺).

The film material herein can also comprise one or more additive ingredients. For example, the film preferably comprises a plasticizing agent. The plasticizing agent may comprise water, glycerol, ethylene glycol, diethylene glycol, propylene glycol, dipropylene glycol, sorbitol, or mixtures thereof. In some aspects, the film comprises from about 2% to about 35%, or from about 5% to about 25%, by weight of the film, a plasticizing agent selected from group comprising water, glycerol, diethylene glycol, sorbitol, and mixtures thereof. In some aspects, the film material comprises at least two, or preferably at least three, plasticizing agents. In some aspects, the film is substantially free of ethanol, meaning that the film comprises from 0% (including 0%) to about 0.1% ethanol by weight of the film. In some aspects, the plasticizing agents are the same as solvents found in an encapsulated liquid composition.

Other additives may include water and functional detergent additives, including surfactant, to be delivered to the wash water, for example, organic polymeric dispersants, etc. Additionally, the film may comprise an aversive agent, further described herein.

The water-soluble unit dose article may comprise an area of print. The water-soluble unit dose article may be printed using flexographic techniques, ink jet printing techniques or a mixture thereof. The printed are may be on the film, preferably on the outside of the film, within the film, on the inside of the film or a mixture thereof. The printed area may convey information such as usage instructions, chemical safety instructions or a mixture thereof. Alternatively, the entire surface of the pouch, or substantially the entire surface of the pouch is printed in order to make the pouch opaque. The print may convey an image that reduces the risk of confusion and hence accidental ingestion of the pouch.

### Detergent or Cleaning Composition

The present disclosure further relates to detergent or cleaning compositions. The detergent or cleaning composition may comprise a first and/or a second aversive agent.

The detergent or cleaning composition may be in the form of a powder, a compacted powder, a liquid, or a mixture thereof. By ‘liquid’ we herein mean any composition capable of wetting and treating a substrate and encompasses forms such as dispersions, gels, pastes and the like. A dispersion, for example, is a liquid comprising solid or particulate matter contained therein. The liquid composition may also include gases in suitably subdivided form.

The unit dose articles described herein may comprise the detergent or cleaning composition, for example by encapsulating the composition in a water-soluble or water-dispersible film. The detergent or cleaning composition may be a fabric detergent or cleaning composition, an automatic dishwashing detergent or cleaning composition or a mixture thereof.

By “fabric detergent or cleaning composition” we herein mean compositions that provide cleaning benefit to fabrics, care benefit to fabrics or a mixture thereof. The fabric detergent or cleaning composition may provide a cleaning benefit selected from stain removal, stain-repellency, anti-soil-redeposition, brightening, whitening dirt removal, malodour reduction or mixtures thereof. The fabric detergent or cleaning composition may provide a care benefit selected from softening, freshness, anti-wrinkling, anti-colour fading, dye transfer inhibition, anti-static or mixtures thereof.

By “automatic dishwashing detergent or cleaning composition” we herein mean automatic dishwashing compositions that provide cleaning benefits, care benefits or a mixture thereof. “Automatic dishwashing care benefits” refers to any automatic dishwashing composition that can provide shine, fast drying, metal, glass or plastic protection benefits.

The cleaning composition may comprise anionic surfactants, non-ionic surfactants, cationic surfactants, polyethylene glycol polymers, ethoxylated polyethyleneimines, rheology modifier, hueing dyes, perfumes, perfume microcapsules, chelants, enzymes, silicones, polyolefin waxes, latexes, oily sugar derivatives, cationic polysaccharides, polyurethanes, fatty acids, enzyme stabilizing systems; antioxidants, opacifier, pearlescent agent, deposition aid, builder, bleaching agent, bleach activator, bleach catalyst, organic shine polymers, surface modifying polymers, metal care agents, metal salts, anti-corrosion agents and mixtures thereof.

The detergent or cleaning composition may comprise from about 1% to 80% by weight of the detergent or cleaning composition of a surfactant. The surfactant may comprise anionic, nonionic, zwitterionic, ampholytic, zwitterionic, semi-polar, cationic surfactants or mixtures thereof. The surfactant may comprise anionic, nonionic, cationic surfactants and mixtures thereof.

The detergent or cleaning composition may comprise an enzyme. The enzyme may be selected from hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof.

The detergent or cleaning composition may comprise a polymer. The polymer may be selected from carboxylate polymers, polyethylene glycol polymers, terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, ethoxylated polyethyleneimines and any combination thereof.

Other polymers include hydroxyethyl cellulose polymer. Preferably, the hydroxyethyl cellulose polymer is derivatised with trimethyl ammonium substituted epoxide. The cellulose polymer may have a molecular weight of between 100,000 and 800,000 daltons. The hydroxyethyl cellulose polymer may be added to the composition as a particle. It may be present in the composition of the particle or may be also be present as a liquid, or a mixture thereof.

The detergent or cleaning composition may comprise a rheology modifier. The rheology modifier can be selected from the group consisting of non-polymeric crystalline hydroxy-functional materials, polymeric rheology modifiers or mixtures thereof. Specific examples of suitable crystalline, hydroxyl-containing rheology modifiers include castor oil and its derivatives. Also practical are hydrogenated castor oil derivatives such as hydrogenated castor oil and hydrogenated castor wax.

The detergent or cleaning composition may comprise a builder. Suitable builders include polycarboxylate builders include cyclic compounds, particularly alicyclic compounds. Particularly suitable are citrate builders, e.g., citric acid and soluble salts thereof, particularly sodium salts thereof. The builder may be selected from aminocarboxylate builders, preferably selected from salts of MGDA (methyl-glycine-diacetic acid), GLDA (glutamic-N,N-diacetic acid), EDDS (ethylene diamine disuccinates), iminodisuccinic acid (IDS), and carboxymethyl inulin.

The detergent or cleaning composition may comprise a bleaching agent. Bleaching agents may comprise chlorine bleaches, oxygen bleaches, or mixtures thereof. The bleach may be selected from sodium perborate monohydrate, sodium perborate tetrahydrates, sodium percarbonate, and mixtures thereof.

The detergent or cleaning composition may comprise a peroxyacid bleach precursors, preferably selected from precursors of perbenzoic acid, cationic peroxyacid precursors, peracetic acid, sodium acetoxybenzene sulfonate, pentaacetylglucose, sodium 3,5,5-trimethylhexanoyloxybenzene sulfonate (iso-NOBS), sodium nonanoyloxybenzene sulfonate (NOBS), amide substituted alkyl peroxyacid precursors, benzoxazin peroxyacid precursors and mixtures thereof. The bleach may comprise ε-phthalimidoperoxycaproic acid[phthaloiminoperoxyhexanoic acid (PAP).

Preferably, if the detergent or cleaning composition comprises an automatic dish washing composition, the automatic dishwashing composition is phosphate free, or substantially phosphate free.

The detergent or cleaning composition may comprise a hueing dye, a brightener or a mixture thereof.

Preferably the detergent or cleaning composition comprises a non-aqueous solvent, preferably between 5% and 30%, more preferably between 7% and 25% by weight of the detergent or cleaning composition of a non-aqueous solvent. Preferably, the non-aqueous solvent is selected from glycerol, ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof.

The detergent or cleaning composition may comprise water, preferably from 0.1% to 20%, more preferably from 0.5% to 15%, most preferably from 1% to 13.5% by weight of the detergent or cleaning composition of water.

### Process of Making

The present disclosure further relates to processes of making the films, compositions, and unit dose articles described herein. For example, first and second aversive agents may be provided to a film, composition, or unit dose article in any suitable manner or order.

The process may comprise the steps of: providing a first aversive agent and a second aversive agent to a unit dose article or component thereof, where the first and second aversive agents are selected so that at least a first portion of a human population can taste the first aversive agent but not the second aversive agent, and so that at least a second portion of the human population can taste the second aversive agent but not the first aversive agent.

The first and second aversive agents may be provided to a water-soluble or water-dispersible film of the unit dose article at a time selected from prior to unit dose formation, during unit dose formation, after unit dose formation, or combinations thereof.

The first and/or second aversive agents may be formulated into the water-soluble or water-soluble film prior to unit dose formation.

The first and/or the second aversive agent may be provided to the unit dose article or component thereof by an action selected from the group consisting of spraying, printing, atomizing, dusting, powdering, coating, painting, or combinations thereof.

A unit dose article may be formed by known methods, for example by providing a first film, thermoforming a cavity, providing a detergent or cleaning composition to the cavity, and sealing the cavity with a second film.

### Methods

Determining the Portion of a Population that can Taste an Aversive Agent

The following method is used to determine what portion of a population can taste an aversive agent.

Sample preparation: An aversive agent is diluted as a 1% solution in ethanol and mixed well. 2 ml of the 1% aversive agent solution is sprayed onto the surface of a water-soluble polyvinyl alcohol film supplied by MonoSol (sprayed surface=11 cm×30 cm) using an airbrush (IWATA® NEO) at a working distance of about 10 cm and with a working pressure of about 25 psi (corresponding to about 1.7 bar).

Test panel population: A population (e.g., n=25) of adult subjects are each given a 2 cm×5 cm piece of coated film. The subjects are asked to lick the film and give a signal as soon as they can detect an unpleasant taste. The timer is started at the moment the subject licks the film, and is stopped the moment the subject gives the signal. This time is recorded as the response time (s). Subjects are then asked to describe the strength of the (unpleasant) taste on a scale of 1 to 5 (1 being mild, 5 being unbearable). Subjects rating the strength of the test as 1 or 2 are counted as “non-tasters,” while consumers rating 3, 4, or 5 are counted as “tasters.”

It may be desired that the same subject is exposed separately to a first aversive agent and a second aversive agent.

Similar tests may be done with a control film that has not been treated with an aversive agent. For example, some previous tests have shown that subjects tasting a water-soluble film that has not been treated with an aversive agent essentially do not suffer an aversive taste reaction (e.g., no reaction within 20 seconds).

A similar protocol may be employed to determine the effective amount for a given aversive agent.

### Method for Measuring Amount of Aversive Agent

The aversive agent may be extracted from the surface via the following method. The unit dose pouch is held with tweezers at the seal. The surface of the each side of the pouch is rinsed 10 times, with 4 to 5 mL of methanol used in each rinse cycle and collected. After rinsing, the methanol solution is transferred to a glass vial, and the methanol is evaporated. The remaining extract is then dissolved in the appropriate solvent needed for the analytical method.

Aversive agents can be assayed via standard methods known to those skilled in the art. Analytical techniques may include chromatography or spectroscopic techniques known to one skilled in the art. For example, suitable methods are disclosed in Falkner et al., Journal of Chromatography A. 715 (1995) 189-194, and in R. Bucci et al., Talanta 68 (2006) 781-790.

### EXAMPLES

The following examples are illustrative in nature and are not intended to limit the scope of the claims in any way.

### Example 1

Table 1 shows hypothetical data from a human population (n=10), determining whether the subjects are tasters of either or both of two aversive agents (A and B).

TABLE 1

| | Taster of Aversive | Taster of Aversive | Taster of |
|---|---|---|---|
| Subject | Agent A | Agent B | A or B? |
| 1 | Yes | Yes | Yes |
| 2 | Yes | Yes | Yes |
| 3 | Yes | Yes | Yes |
| 4 | NO | Yes | Yes |
| 5 | Yes | Yes | Yes |
| 6 | Yes | NO | Yes |
| 7 | NO | NO | NO |
| 8 | NO | Yes | Yes |
| 9 | Yes | Yes | Yes |
| 10 | Yes | Yes | Yes |
| Totals (%): | 70% | 80% | 90% |

As can be seen from the Table 1, providing two different aversive agents can facilitate the creation of compositions that provide an effective aversive effect for a greater portion of a population.

### Example 2

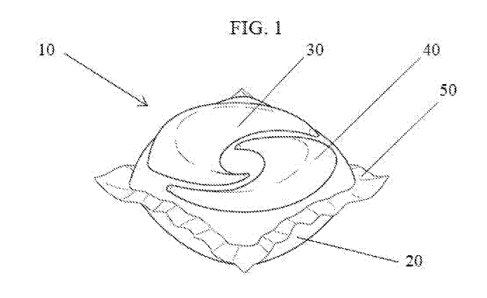

FIG. 1 shows a unit dose article 10. The unit dose article 10 has a bottom compartment 20 and two top compartments 30, 40 that are formed from water-soluble film 50. A detergent composition is contained in at least one of the compartments 20, 30, 40. The water-soluble film 50 includes two aversive agents, such as denatonium benzoate and capsaicin, present in effective amounts. The film 50 is formed by providing a film-forming material, adding the aversive agents to form a mixture, and then casting the mixture to form the film 50. The film may be thermoformed and sealed to form the compartments 20, 30, 40.

### Example 3

A unit dose article 10 such as the one described in Example 2 is provided, but the aversive agents are added to the film via dusting after the unit dose article has been formed.

### Example 4

A unit dose article 10 such as the one described in Example 2 is provided, but the aversive agents are added to the film via spraying after the unit dose article 10 has been formed.

### Example 5

A unit dose article 10 such as the one described in Example 2 is provided, but only one aversive agent, e.g., denatonium benzoate, is added to the film-forming mixture. The other aversive agent, e.g., capsaicin, is added after the film has been formed. It may be added before the unit dose article 10 has been formed, and/or it may be added after the unit dose article 10 has been formed.

### Example 6

A unit dose article 10 such as the one described in Example 2 is provided, but the aversive agents include denatonium benzoate and sucrose octaacetate.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A water-soluble unit dose article comprising:
a first aversive agent present in an effective amount, and
a second aversive agent present in an effective amount,
wherein the first and second aversive agents are different.

2. A unit dose article according to claim 1, wherein the first and second aversive agents are selected so that at least a first portion of a human population can taste the first aversive agent but not the second aversive agent, and so that at least a second portion of the human population can taste the second aversive agent but not the first aversive agent.

3. A unit dose article according to claim 1, wherein the first aversive agent is a first bittering agent.

4. A unit dose article according to claim 3, wherein the first bittering agent comprises a denatonium salt or a derivative thereof.

5. A unit dose article according to claim 4, wherein the first bittering agent comprises denatonium benzoate.

6. A unit dose article according to claim 3, wherein the second aversive agent is a second bittering agent.

7. A unit dose article according to claim 3, wherein the second aversive agent is a pungent agent.

8. A unit dose article according to claim 1, wherein the first aversive agent is selected from the group consisting of naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-methoxy-4′-hydroxy-phenyl)-1, 3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

9. A unit dose article according to claim 1, wherein the second aversive agent is selected from the group consisting of naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-methoxy-4′-hydroxy-phenyl)-1, 3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

10. A unit dose article according to claim 1, wherein the first aversive agent is present at a concentration of from about 0.0001% to about 5%, by weight of the article.

11. A unit dose article according to claim 1, wherein the second aversive agent is present at a concentration of from about 0.0001% to about 5%, by weight of the article.

12. A unit dose article according to claim 1, wherein the first aversive agent and the second aversive agent are present in a weight ratio of from about 0.01:99.99 to about 99.99:0.01.

13. A unit dose article according to claim 1, wherein the unit dose article comprises a water-soluble or water-dispersible film that encapsulates a detergent or cleaning composition.

14. A unit dose article according to claim 13, wherein the first aversive agent is in or on the film.

15. A unit dose article according to claim 14, wherein the second aversive agent is in or on the film.

16. A unit dose article according to claim 1, wherein the first aversive agent is present at a first location of the unit dose article, wherein the second aversive agent is present at a second location of the unit dose article, and wherein the first and second locations are different.

17. A unit dose article according to claim 16, wherein the first location is in or on a first water-soluble or water-dispersible film, and wherein the second location is in or on a second water-soluble or water-dispersible film.

18. A unit dose article according to claim 16, wherein the first location is in a water-soluble or water-dispersible film, and wherein the second location is on the water-soluble or water-dispersible film.

19. A process for making a unit dose article, the process comprising the steps of:
providing a first aversive agent and a second aversive agent to a unit dose article or component thereof,
wherein the first and second aversive agents are selected so that at least a first portion of a human population can taste the first aversive agent but not the second aversive agent, and so that at least a second portion of the human population can taste the second aversive agent but not the first aversive agent.

20. A process according to claim 19, wherein the first and second aversive agents are provided to a water-soluble or water-dispersible film of the unit dose article at a time selected from prior to unit dose formation, during unit dose formation, after unit dose formation, or combinations thereof.

21. A process according to claim 20, wherein the first and second aversive agents are formulated into the water-soluble or water-soluble film prior to unit dose formation.

22. A process according to claim 19, wherein the first and/or the second aversive agent are provided to the unit dose article or component thereof by an action selected from the group consisting of spraying, printing, atomizing, dusting, powdering, coating, painting, or combinations thereof.

23. A cleaning or detergent composition comprising:
a first aversive agent present in an effective amount, and
a second aversive agent present in an effective amount,
wherein the first and second aversive agents are different.

24. A cleaning or detergent composition according to claim 23, wherein the first and second aversive agents are selected so that at least a first portion of a human population can taste the first aversive agent but not the second aversive agent, and so that at least a second portion of the human population can taste the second aversive agent but not the first aversive agent.

25. A water-soluble film comprising:
a first aversive agent present in an effective amount, and
a second aversive agent present in an effective amount,
wherein the first and second aversive agents are different, and
wherein the first and second aversive agents are selected so that at least a first portion of a human population can taste the first aversive agent but not the second aversive agent, and so that at least a second portion of the human population can taste the second aversive agent but not the first aversive agent.
